(19) United States
(12) Patent Application Publication
(10) Pub. No.: US 2005/0211870 A1
(43) Pub. Date: Sep. 29, 2005

(54) Active and reconfigurable tools

(76) Inventors: Alan L. Browne, Grosse Pointe, MI (US); Nancy L. Johnson, Northville, MI (US)

Correspondence Address: KATHRYN A. MARRA;General Motors Corporation, Legal Staff, Mail Code 482-C23-B21, P.O. Box 300, Detroit, MI, 48265-3000, US

(21) Appl. No.: 11/075,837

(22) Filed: Mar. 9, 2005

Related U.S. Application Data
(60) Provisional application No. 60/552,677, filed on Mar. 12, 2004.
(60) Provisional application No. 60/654,985, filed on Feb. 22, 2005.

(51) Int. Cl. B29C 33/40

(52) U.S. Cl. 249/134; 264/337; 264/219

(57) ABSTRACT

Disclosed herein is a reconfigurable tool for use in a mold comprising an active element that comprises an active material, wherein the active element upon activation is operative to permit insertion or removal of the reconfigurable tool from an opening in the mold or a molded part. Disclosed herein too is method for using a reconfigurable tool during a molding operation comprising pouring a molten polymeric resin, metal, ceramic, or a combination comprising a molten polymeric resin, metal or ceramic into a mold that comprises a reconfigurable tool, wherein the reconfigurable tool comprises an active element that is activated upon the application of an external stimulus; and activating the active element.

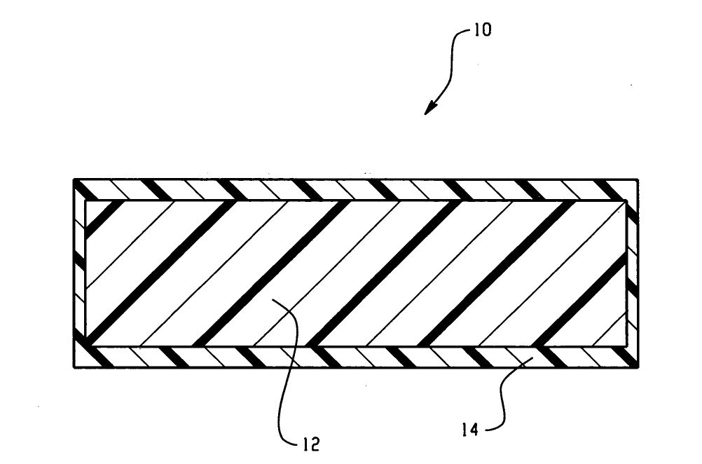

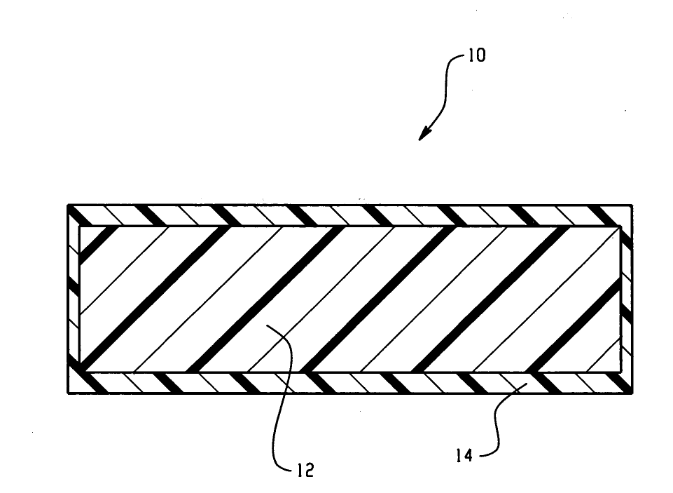

### CROSS-REFERENCE TO RELATED APPLICATIONS

This application claims the benefit of U.S. Provisional Application Ser. No 60/552,677 filed Mar. 12, 2004 and U.S. Provisional Application Ser. No 60/654,985 filed Feb. 22, 2005 the entire contents of which are hereby incorporated by reference.

### BACKGROUND

The present disclosure relates to reconfigurable tooling for the fabrication of structures from materials such as metals, ceramics and/or organic polymers. More particularly, the present disclosure relates to compositions of materials that are suitable for the inexpensive fabrication of molds, mandrels, or the like. It is expected that these molds and or mandrels can be used most commonly for the fabrication of nonmetallic, plastic, or composite structures.

In the fabrication of so-called composites for use in the automotive, aircraft and aerospace industry, tooling and assembly costs are major drivers. Conventional tooling for the fabrication of composites generally has a fixed geometry and is very costly to manufacture. Additionally, such fixed geometry tooling displays short lifetimes and demonstrate inappropriate shrinking characteristics.

Aluminum is used as tooling material for low volume production, up to 100 parts, whereas steel is used as tooling material for volumes over about 100 parts. For the creation of master patterns, plaster is generally used, followed by wood, modeling board and aluminum. Invar (iron-nickel) has been used to some extent in the aerospace industry because of a good match of thermal expansion coefficients with those of graphite/epoxy materials. This tooling material is, however, expensive and requires large lead times for machining. As a result, efforts have been made in developing computer aided design software to reduce the time needed for tooling design to shorten the overall prototype or product fabrication cycle.

The aforementioned problems with tooling are generally acute in the fabrication of components, either hollow or with cavities, requiring the use of mandrels or the like. Commonly used types of mandrels include: nylon bagged styrofoam cores; solid metal mandrels; soft inflatable bladders; hollow silicone mandrels, thermoplastic mandrels; machined foam flyaway; and water soluble substances such as eutectic salts. In the use of such systems, demolding and materials costs are significant problems. As a consequence, most mandrels are machined from solid pieces of material such as aluminum or cast into a fixed shape and cannot be easily reconfigured.

Accordingly, the availability of relatively low cost tooling including die inserts and mandrels that is reconfigurable and readily and cheaply fabricated would be of value to the aircraft, aerospace, and automotive industries in the fabrication of composite structures.

### SUMMARY

Disclosed herein is a reconfigurable tool for use in a mold comprising an active element that comprises an active material, wherein the active element upon activation is operative to permit insertion or removal of the reconfigurable tool from an opening in the mold or a molded part.

Disclosed herein too is a method for using a reconfigurable tool during a molding operation comprising pouring a molten polymeric resin, metal, ceramic, or a combination comprising a molten polymeric resin, metal or ceramic into a mold that comprises a reconfigurable tool, wherein the reconfigurable tool comprises an active element that can be activated upon the application of an external stimulus; and activating the active element.

Disclosed herein too is a method comprising inserting a hollow reconfigurable tool comprising an active element and having a first shape and/or a first set of dimensions into a first mold; activating the active element; inflating the reconfigurable tool; deactivating the active element to lock in a second shape and/or a second set of dimensions in the reconfigurable tool to form a new reconfigurable tool; depressurizing the new reconfigurable tool; and removing the new reconfigurable tool from the first mold.

### DETAILED DESCRIPTION OF THE DRAWINGS

The Figure is an exemplary depiction of a reconfigurable tool 10 that comprises a core 12 and a coating 14.

### DETAILED DESCRIPTION OF PREFERRED EMBODIMENTS

The present disclosure addresses the high cost of manufacture of composite structures by describing a class of compositions that can be easily, and cheaply fabricated into tooling that is readily reconfigurable when changes must be made. This tooling is termed “reconfigurable tooling”. The compositions, their method of manufacture and tooling made therefrom are all described herein. In one embodiment, the entire reconfigurable tool comprises an active element that can be manufactured entirely from active materials. In another embodiment, only a portion of the reconfigurable tooling comprises an active element that can be manufactured from active materials. Suitable examples of reconfigurable tooling that can be made from active materials are molds, die or mold inserts, mandrels, bladders, or the like, or a combination comprising at least one of the foregoing tools. The tools may be used in molding operations or the like.

Disclosed herein too is a method comprising inserting a reconfigurable tool that comprises at least in part an active material into a mold to serve variously as an insert, a mandrel, and/or a bladder; pouring a molten polymeric resin, metal, ceramic, or a combination comprising a molten polymeric resin, metal or ceramic into the mold in a manner effective to surround the mandrel; and in certain of the embodiments activating the active material after molding of the part has been completed to facilitate its removal from the mold and/or part. In one embodiment, the active material is activated prior to or during the molding operation in order to change dimensions of the molded part. In another embodiment, the active material is activated variously before, during and/or after the molding operation in order to impart special features such as design, ornamental or functional features—even non bas relief surface features that would otherwise result in die lock in the molded component.

The use of active materials in reconfigurable tools advantageously reduces the high cost of manufacture since such tools are readily reconfigurable when dimensional or geometrical changes must be made. The tools may be used in molding operations or the like.

In many molding operations, it is desirable to manufacture parts that have tight tolerances. In such operations, it is often desirable to remove a mandrel from a tightly toleranced enclosure in the mold and/or component after the component is molded. Often the molded component does not contain a large enough opening to remove the mandrel or the molded component and its interior cavity are of such irregular shapes that the mandrel cannot be oriented so as to be able to remove it from the molded component. By utilizing a mandrel at least a portion of which comprises an active material, an external stimulus may be applied to the mandrel after the molding operation to change the size, shape or stiffness so that it can be easily removed from the tightly toleranced enclosure. For example, in a molding operation, the mandrel comprising an active element manufactured from a shape memory alloy is placed in the mold. The molten organic polymeric resin, metal, ceramic or a combination thereof is poured into the mold. After the pouring, the melt is cooled down to below the solidification temperature. The mandrel is then heated to a temperature above the austenitic transition temperature to promote a reduction in the size of the mandrel. The mandrel can now be easily removed from the tightly toleranced enclosure.

A reconfigurable tool generally refers to reconfigurable mold inserts such as, for example, mandrels and bladders comprised at least in part of an active material for use in molding hollow bodies/bodies with cavities. In one embodiment, reconfigurable tools can be used in molds where cavities are either irregularly shaped and/or are of larger dimensions than the opening through which the mandrel is to be withdrawn. In another embodiment, the reconfigurable tools are used where the molded product is of a sufficiently irregular shape such as those with non-bas relief surface features (e.g., surface features with undercut) that otherwise would have resulted in die lock without the use of the reconfigurable tool.

The term “reconfigurable” as used here refers to reversible changes in dimensions, shape, and/or stiffness of the tooling by the activation of active materials that are used in the manufacture of this tooling. The reversible changes refer to changes in dimensions, shape, and/or stiffness that can take place either before, during or after the molding operation upon activation by an external stimulus.

There are several different classes of applications of reconfigurable tools. In one embodiment, the reconfigurable tool can be reversibly reconfigured through the activation of the active materials prior to the molding of objects so as to make it possible to use the same molds and inserts to mold components of, for example different geometries, dimensions, surface features, and/or wall thicknesses. In another embodiment, the reconfigurable tools. can be changed through the activation of active materials after molding of the component has been completed. so as to allow removal of the reconfigurable tools and the component from the mold and/or from the molded object.

In one embodiment, therefore, a reconfigurable tool is one that comprises an active element comprising a shape memory alloy, wherein the reconfigurable tool can change from a first shape to a second shape upon activation. The first shape can have at least one dimension that is different from that of the second shape. In one embodiment, this dimension can be greater when in the first shape than when in the second shape. In another embodiment, this dimension can be greater when in the second shape than when in the first shape.

In another embodiment, a reconfigurable tool is one that comprises an active element comprising a shape memory alloy, wherein the reconfigurable tool can undergo a change in stiffness from a first elastic modulus to a second elastic modulus upon activation. The change in stiffness can be accompanied by a change in shape. In one embodiment, the first elastic modulus can be greater than the second elastic modulus, while in another embodiment, the second elastic modulus can be greater than the first elastic modulus.

Thus,. a reconfigurable tool for use in a mold comprises an active element that comprises an active material, and wherein the active element upon activation can undergo a reversible change from a first shape to a second shape, a reversible change from a first set of dimensions to a second set of dimensions, and/or a reversible change from a first elastic modulus to a second elastic modulus. This change in shape, dimensions, and/or elastic modulus permits the insertion and/or removal of the reconfigurable tool into and/or from an opening in the mold and/or the molded part, through which it could not have been inserted and/or removed prior to activation.

Additionally, the reconfigurable tools can be advantageously used in the molding of bodies having irregular shapes such as, for example, those with non bas relief surface features (e.g., surface features with undercut) that otherwise would have resulted in die lock during the molding operation. Additionally, the reversible reconfiguration of the dimensions and/or shape of the reconfigurable tool prior to, during and/or after the molding of a component makes it possible to use the same reconfigurable tool to mold objects having different geometries, surface features, and wall thicknesses. For example, the reconfigurable tool used in a first molding operation can be reconfigured into a mold having a different shape for a second molding operation.

In one embodiment, the active materials used in the active element of the reconfigurable tool are shape memory materials. Shape memory materials generally refer to materials or compositions that have the ability to remember their original shape, which can subsequently be recalled by applying an external stimulus, i.e., an activation signal. As such, deformation of the shape memory materials from the original shape can be a temporary condition, which can be used for varying the shape and/or stiffness of the active element. Exemplary shape memory materials suitable for use in the present disclosure include one-way (the most mature form) shape memory alloys, ferromagnetic shape memory alloys, shape memory polymers, and composites of the foregoing shape memory materials with non-shape memory materials, and combinations comprising at least one of the foregoing shape memory materials. In another embodiment, the class of active materials used in the reconfigurable tools are those that change their shape in proportion to the strength of the applied field but then return to their original shape upon the discontinuation of the field.

Exemplary active materials in this category are two-way shape memory alloys, electroactive polymers (dielectric polymers), piezoelectrics, magnetorheological polymers, or a combination comprising at least one of the foregoing active materials. Active materials generally use an external stimuli such as electricity, magnetism, thermal energy, radiation, chemical energy, or the like, to undergo a change in shape and/or stiffness. This change in shape or stiffness results in the development of a force that is transmitted to the article via suitable connecting means to promote a positioning or shaping of the reconfigurable tool.

In still another embodiment, the class of active materials used in the reconfigurable tools are those that reversibly change their shear strength in proportion to the strength of the applied filed but return to their original starting shear strength upon removal of the field. Exemplary active materials in this category are magnetorheological fluids (MR) and electrorheological fluids (ER).

Shape memory alloys (SMA's) generally refer to a group of metallic materials that demonstrate the ability to return to some previously defined shape or size when subjected to an appropriate thermal stimulus. Shape memory alloys are capable of undergoing phase transitions in which their flexural modulus, yield strength, and shape orientation are altered as a function of temperature. Generally, in the low temperature, or martensite phase, shape memory alloys can be plastically deformed and upon exposure to some higher temperature will transform to an austenite phase, or parent phase, returning to their shape prior to the deformation. Materials that exhibit this shape memory effect only upon heating are referred to as having one-way shape memory. Those materials that also exhibit shape memory upon re-cooling are referred to as having two-way shape memory behavior.

Shape memory alloys can exhibit a one-way shape memory effect, an intrinsic two-way effect, or an extrinsic two-way shape memory effect depending on the alloy composition and processing history. Annealed shape memory alloys typically only exhibit the one-way shape memory effect. Sufficient heating subsequent to low-temperature deformation of the shape memory material will induce the martensite to austenite type transition, and the material will recover the original, annealed shape. Hence, one-way shape memory effects are only observed upon heating.

Intrinsic and extrinsic two-way shape memory alloy materials are characterized by a shape transition both upon heating from the martensite phase to the austenite phase, as well as an additional shape transition upon cooling from the austenite phase back to the martensite phase. Active elements that exhibit an intrinsic one-way shape memory effect are fabricated from a shape memory alloy composition that will cause the connector elements to automatically reform themselves as a result of the above noted phase transformations. Intrinsic two-way shape memory behavior must be induced in the shape memory material through processing. Such procedures include extreme deformation of the material while in the martensite phase, heating-cooling under constraint or load, or surface modification such as laser annealing, polishing, or shot-peening. Once the material has been trained to exhibit the two-way shape memory effect, the shape change between the low and high temperature states is generally reversible and persists through a high number of thermal cycles. In contrast, active connector elements that exhibit the extrinsic two-way shape memory effects are composite or multi-component materials that combine a shape memory alloy composition that exhibits a one-way effect with another element that provides a restoring force to return the first plate another position or to its original position.

The temperature at which the shape memory alloy remembers its high temperature form when heated can be adjusted by slight changes in the composition of the alloy and through heat treatment. In nickel-titanium shape memory alloys, for instance, it can be changed from above about 100° C. to below about −100° C. The shape recovery process occurs over a range of just a few degrees and the start or finish of the transformation can be controlled to within a degree or two depending on the desired application and alloy composition.

Suitable shape memory alloy materials for fabricating the active elements include nickel-titanium based alloys, indium-titanium based alloys, nickel-aluminum based alloys, nickel-gallium based alloys, copper based alloys (e.g., copper-zinc alloys, copper-aluminum alloys, copper-gold, and copper-tin alloys), gold-cadmium based alloys, silver-cadmium based alloys, indium-cadmium based alloys, manganese-copper based alloys, iron-platinum based alloys, iron-palladium based alloys, or the like, or a combination comprising at least one of the foregoing shape memory alloys. The alloys can be binary, ternary, or any higher order so long as the alloy -composition exhibits a shape. memory effect, e.g., change in shape orientation, changes in yield strength, and/or flexural modulus properties, damping capacity, and the like.

The shape memory alloys used in the active element may have any geometrical shape from which a change in shape and/or stiffness may be used to promote the reconfiguration of the tool. This change in shape and/or stiffness is brought about by an activation signal. An exemplary activation signal is a thermal activation signal. The thermal activation signal may be applied to the shape memory alloy in various ways. It is generally desirable for the thermal activation signal to promote a change in the temperature of the shape memory alloy to a temperature greater than or equal to its austenitic transition temperature. Suitable examples of such thermal activation signals that can promote a change in temperature are the use of steam, hot oil, resistive electrical heating, or the like, or a combination comprising at least one of the foregoing signals. A preferred thermal activation signal is one derived from resistive electrical heating.

Shape memory polymers (SMP's) may also be used in the reconfigurable tools. SMP's generally refer to a group of polymeric materials that demonstrate the ability to return to some previously defined shape when subjected to an appropriate thermal stimulus while under very little to no external load. Shape memory polymers also display a huge drop in modulus by a factor of about 30 to about 100, depending on their composition, when subjected to a temperature above the glass transition temperature of their lower temperature segment. Shape memory polymers are capable of undergoing phase transitions in which their shape orientation is altered as a function of temperature. Generally, SMP's have two main segments, a hard segment and a soft segment. The previously defined or permanent shape can be set by melting or processing the polymer at a temperature higher than the highest thermal transition followed by cooling below that thermal transition temperature. The highest thermal transition is usually the glass transition temperature (Tg) or melting point of the hard segment. A temporary shape can be set by heating the material to a temperature higher than the Tg or the transition temperature of the soft segment, but lower than the Tg or melting point of the hard segment. The temporary shape is set while processing the material at the transition temperature of the soft segment followed by cooling to fix the shape. The material can be reverted back to the permanent shape by heating the material while under little to no load above the transition temperature of the soft segment.

Generally, SMPs are copolymers comprised of at least two different units which may be described as defining different segments within the co-polymer, each segment contributing differently to the flexural modulus properties and thermal transition temperatures of the material. The term “segment” refers to a block, graft, or sequence of the same or similar monomer or oligomer units that are copolymerized with a different segment to form a continuous crosslinked-interpenetrating network of these segments. These segments may be combinations of crystalline or amorphous materials and therefore may be generally classified as a hard segment(s) or a soft segment(s), wherein the hard segment generally has a higher glass transition temperature (Tg) or melting point than the soft segment. Each segment then contributes to the overall flexural modulus properties of the SMP and the thermal transitions thereof. When multiple segments are used, multiple thermal transition temperatures may be observed, wherein the thermal transition temperatures of the copolymer may be approximated as weighted averages of the thermal transition temperatures of its comprising segments. The previously defined or permanent shape of the SMP can be set by blow molding the polymer at a temperature higher than the highest thermal transition temperature for the shape memory polymer or its melting point, followed by cooling below that thermal transition temperature.

In practice, in one embodiment of the present invention the SMP's employed as the active element are alternated between one of at least two shape orientations such that at least one orientation will provide a size reduction relative to the other orientation(s) when an appropriate thermal signal is provided which size reduction could assist removal from the mold/molded component. To set a permanent shape, the shape memory polymer must be at about or above its melting point or highest transition temperature (also termed “last” transition temperature). The active element is generally shaped at this temperature by molding or shaped with an applied force followed by cooling to set the permanent shape.

In another embodiment, the SMP's employed as the active element are thermally activated to produce a huge drop in modulus. The then highly flexible SMP insert then can be readily deformed so as to facilitate removal from the molded part or non bas relief features of the molded part. This thermal activation can alternatively be used in combination with applied forces to allow reversible reshaping of the SMP based tool prior to molding components.

The temperature to set the permanent shape is generally between about 40° C. to about 300° C. The Tg of the SMP can be chosen for a particular application by modifying the structure and composition of the polymer. Transition temperatures of suitable SMPs generally range in an amount of about −63° C. to above about 160° C. Engineering the composition and structure of the polymer itself can allow for the choice of a particular temperature for a desired application. A preferred temperature for shape recovery is greater than or equal to about −30° C, more preferably greater than or equal to about 20° C., and most preferably a temperature greater than or equal to about 70° C. Also, a preferred temperature for shape recovery is less than or equal to about 250° C., more preferably less than or equal to about 200° C., and most preferably less than or equal to about 180° C.

Suitable shape memory polymers can be thermoplastics, interpenetrating networks, semi-interpenetrating networks, or mixed networks. The polymers can be a single polymer or a blend of polymers. The polymers can be linear or branched thermoplastic elastomers with side chains or dendritic structural elements. Suitable polymer components to form a shape memory polymer include, but are not limited to, polyphosphazenes, poly(vinyl alcohols), polyamides, polyester amides, poly(amino acid)s, polyanhydrides, polycarbonates, polyacrylates, polyalkylenes, polyacrylamides, polyalkylene glycols, polyalkylene oxides, polyalkylene terephthalates, polyortho esters, polyvinyl ethers, polyvinyl esters, polyvinyl halides, polyesters, polylactides, polyglycolides, polysiloxanes, polyurethanes, polyethers, polyether amides, polyether esters, and copolymers thereof. Examples of suitable polyacrylates include poly(methyl methacrylate), poly(ethyl methacrylate), poly(butyl methacrylate), poly(isobutyl methacrylate), poly(hexyl methacrylate), poly(isodecyl methacrylate), poly(lauryl methacrylate), poly(phenyl methacrylate), poly(methyl acrylate), poly(isopropyl acrylate), poly(isobutyl acrylate) and poly(octadecyl. acrylate). Examples of other suitable polymers include polystyrene, polypropylene, polyvinyl phenol, polyvinylpyrrolidone, chlorinated polybutylene, poly(octadecyl vinyl ether), ethylene vinyl acetate, polyethylene, poly(ethylene oxide)-poly(ethylene terephthalate), polyethylene/nylon (graft copolymer), polycaprolactones-polyamide (block copolymer), poly(caprolactone) dimethacrylate-n-butyl acrylate, poly(norbornyl-polyhedral oligomeric silsequioxane), polyvinylchloride, urethane/butadiene copolymers, polyurethane block copolymers, styrene-butadiene-styrene block copolymers, or the like, or a combination comprising at least one of the foregoing polymers.

As with the shape memory alloys, when a shape memory polymer is used as the active element in the reconfigurable tool, a variety of geometrical shapes, as listed above, may be utilized. Additionally a variety of activation signals may be used. The preferred activation signal is a thermal activation signal provided by heating, exemplary means being conductive, convective, radiative, and resistive or combinations thereof.

As noted above the active element in the reconfigurable tool may be a magnetorheological fluid. The term magnetorheological fluid encompasses magnetorheological fluids, magnetorheological elastomers, ferrofluids, colloidal magnetic fluids, and the like. Magnetorheological (MR) fluids and elastomers are known as “active” materials whose rheological properties can rapidly change upon application of a magnetic field. MR fluids are suspensions of micrometer-sized, magnetically polarizable particles in oil or other liquids. When a MR fluid is exposed to, a magnetic field, the normally randomly oriented particles form chains of particles in the direction of the magnetic field lines. The particle chains increase the apparent viscosity (flow resistance) of the fluid. The stiffness, of the structure is accomplished by changing the shear and compression/tension modulii of the MR fluid by varying the .strength of the applied magnetic field. The MR fluids typically develop structure when exposed to a magnetic field in as little as a few milliseconds. Discontinuing the exposure of the MR fluid to the magnetic field reverses the process and the fluid returns to a lower viscosity state.

Suitable magnetorheological fluids include ferromagnetic or paramagnetic particles dispersed in a carrier fluid. Suitable particles include iron; iron alloys, such as those including aluminum, silicon, cobalt, nickel, vanadium, molybdenum, chromium, tungsten, manganese and/or copper; iron oxides, including Fe₂O₃ and Fe₃O₄; iron nitride; iron carbide; carbonyl iron; nickel and alloys of nickel; cobalt and alloys of cobalt; chromium dioxide; stainless steel; silicon steel; or the like, or a combination comprising at least one of the foregoing particles. Examples of suitable iron particles include straight iron powders, reduced iron powders, iron oxide powder/straight iron powder mixtures and iron oxide powder/reduced iron powder mixtures. A preferred magnetic-responsive particulate is carbonyl iron, preferably, reduced carbonyl iron.

The particle size should be selected so that the particles exhibit multi-domain characteristics when subjected to a magnetic field. Diameter sizes for the particles can be less than or equal to about 1,000 micrometers, with less than or equal to about 500 micrometers preferred, and less than or equal to about 100 micrometers more preferred. Also preferred is a particle diameter of greater than or equal to about 0.1 micrometer, with greater than or equal to about 0.5 more preferred, and greater than or equal to about 10 micrometer especially preferred. The particles are preferably present in an amount between about 5.0 and about 50 percent by volume of the total composition.

Suitable carrier fluids include organic liquids, especially non-polar organic liquids. Examples include, but are not limited to, silicone oils; mineral oils; paraffin oils; silicone copolymers; white oils; hydraulic oils; transformer oils; halogenated organic liquids, such as chlorinated hydrocarbons, halogenated paraffins, perfluorinated polyethers and fluorinated hydrocarbons; diesters; polyoxyalkylenes; fluorinated silicones; cyanoalkyl siloxanes; glycols; synthetic hydrocarbon oils, including both unsaturated and saturated; and combinations comprising at least one of the foregoing fluids.

The viscosity of the carrier component can be less than or equal to about 100,000 centipoise, with less than or equal to about 10,000 centipoise preferred, and less than or equal to about 1,000 centipoise more preferred. Also preferred is a viscosity of greater than or equal to about 1 centipoise, with greater than or equal to about 250 centipoise preferred, and greater than or equal to about 500 centipoise especially preferred.

Aqueous carrier fluids may also be used, especially those comprising hydrophilic mineral clays such as bentonite and hectorite. The aqueous carrier fluid may comprise water or water comprising a small amount of polar, water-miscible organic solvents such as methanol, ethanol, propanol, dimethyl sulfoxide, dimethyl formamide, ethylene carbonate, propylene carbonate, acetone, tetrahydrofuran, diethyl ether, ethylene glycol, propylene glycol, and the like. The amount of polar organic solvents is less than or equal to about 5.0% by volume of the total MR fluid, and preferably less than or equal to about 3.0%. Also, the amount of polar organic solvents is preferably greater than or equal to about 0.1%, and more preferably greater than or equal to about 1.0% by volume of the total MR fluid. The pH of the aqueous carrier fluid is preferably less than or equal to about 13, and preferably less than or equal to about 9.0. Also, the pH of the aqueous carrier fluid is greater than or equal to about 5.0, and preferably greater than or equal to about 8.0.

Natural or synthetic bentonite or hectorite may be used. The amount of bentonite or hectorite in the MR fluid is less than or equal to about 10 percent by weight of the total MR fluid, preferably less than or equal to about 8.0 percent by weight, and more preferably less than or equal to about 6.0 percent by weight. Preferably, the bentonite or hectorite is present in greater than or equal to about 0.1 percent by weight, more preferably greater than or equal to about 1.0 percent by weight, and especially preferred greater than or equal to about 2.0 percent by weight of the total MR fluid.

Optional components in the MR fluid include clays, organoclays, carboxylate soaps, dispersants, corrosion inhibitors, lubricants, extreme pressure anti-wear additives, antioxidants, thixotropic agents and conventional suspension agents. Carboxylate soaps include ferrous oleate, ferrous naphthenate, ferrous stearate, aluminum di- and tri-stearate, lithium stearate, calcium stearate, zinc stearate and sodium stearate, and surfactants such as sulfonates, phosphate esters, stearic acid, glycerol monooleate, sorbitan sesquioleate, laurates, fatty acids, fatty alcohols, fluoroaliphatic polymeric esters, and titanate, aluminate and zirconate coupling agents and the like. Polyalkylene diols, such as polyethylene glycol, and partially esterified polyols can also be included.

Suitable MR elastomer materials include an elastic polymer matrix comprising a suspension of ferromagnetic or paramagnetic particles, wherein the particles are described above. Suitable polymer matrices include poly-alpha-olefins, copolymers of poly-alpha-olefins and natural rubber. In some situations, formulations that may be described as MR elastomers may also fall under the definition of fluids, and vice versa. The MR elastomers have an elastic modulus that is reversibly dependent on the strength of the applied magnetic field.

The reconfigurable tool can be configured to deliver an activation signal to the active elements, wherein the activation signal comprises a magnetic signal. The magnetic signal is a magnetic field. The magnetic field may be generated by a permanent magnet, an electromagnet, or combinations comprising at least one of the foregoing. Suitable magnetic flux densities for the active elements comprised of MR fluids or elastomers range from greater than about 0 to about 1 Tesla. Suitable magnetic flux densities for the magnetic materials used in the active element tools are about 0 to about 1 Tesla.

As noted above, the active element may be an electrorheological fluid. Electrorheological fluids are most commonly colloidal suspensions of fine particles in non-conducting fluids. Under an applied electric field, electrorheological fluids form fibrous structures that are parallel to the applied field and can increase in viscosity by a factor of up to 10⁵. The change in viscosity is generally proportional to the applied potential. ER fluids are made by suspending particles in a liquid whose dielectric constant or conductivity is mismatched in order to create dipole particle interactions in the presence of an alternating current (ac) or direct current (dc) electric field.

The active element may also be an electroactive polymer (EAP).

The design feature of devices based on these materials is the use of compliant electrodes that enable polymer films to expand or contract in the in-plane directions in response to applied electric fields or mechanical stresses. When EAP's are used as the active element, strains of greater than or equal to about 100%, pressures greater than or equal to about 50 kilograms/square centimeter (kg/cm²) can be developed in response to an applied voltage. The good electromechanical response of. these materials, as well as other characteristics such as good environmental tolerance and long-term durability, make them suitable for active elements under a variety of manufacturing conditions. EAP's are suitable for use as an active element, in many reconfigurable tool configurations including stacks, rolls, tubes, unimorphs, bimorphs, diaphragms, and inchworm-like devices.

EAP's used in reconfigurable tools may be selected based on one or more material properties such as a high electrical breakdown strength, a low modulus of elasticity-(for large or small deformations), a high dielectric constant, and the like. In one embodiment, a polymer is selected such that is has an elastic modulus at most about 100 MPa. In another embodiment, the polymer is selected such that is has a maximum actuation pressure between about 0.05 MPa and about 10 MPa, and preferably between about 0.3 MPa and about 3 MPa. In another embodiment, the polymer is selected such that is has a dielectric constant between about 2 and about 20, and preferably between about 2.5 and about 12. The present disclosure is not intended to be limited to these ranges. Ideally, materials with a higher dielectric constant than the ranges given above would be desirable if the materials had both a high dielectric constant and a high dielectric strength. In many cases, electroactive polymers may be fabricated and implemented as thin films. Thicknesses suitable for. these thin films may be below 50 micrometers.

EAP's may deflect at high strains, electrodes attached to the polymers should also deflect without compromising mechanical or electrical performance. Generally, electrodes suitable for use may be of any shape and material provided that they are able to supply a suitable voltage to the EAP. The voltage may be either constant or varying over time. In one embodiment, the electrodes adhere to a surface of the polymer. Electrodes adhering to the polymer are preferably compliant and conform to the changing shape of the polymer. Correspondingly, the present disclosure may include compliant electrodes that conform to the shape of an electroactive polymer to which they are attached. The electrodes may be only applied to, a portion of an electroactive polymer and define an active area according to their. geometry. Various types of electrodes suitable for use with the present disclosure include structured electrodes comprising metal traces and charge distribution layers, textured electrodes comprising varying out of plane dimensions, conductive greases such as carbon greases or silver greases, colloidal suspensions, high aspect ratio conductive materials such as carbon fibrils and carbon nanotubes, and mixtures of ionically conductive materials.

Materials used for electrodes may vary. Suitable materials used in an electrode may include graphite, carbon black, colloidal suspensions, thin metals including silver and gold, silver filled and carbon filled gels and polymers, and ionically or electronically conductive polymers. It is understood that certain electrode materials may work well with particular polymers and may not work as well for others. By way of example, carbon fibrils work well with acrylic elastomer polymers while not as well with silicone polymers.

The EAP's used herein, are generally conjugated polymers. Suitable examples of EAP's are poly(aniline), substituted poly(aniline)s, polycarbazoles, substituted polycarbazoles, polyindoles, poly(pyrrole)s, substituted poly(pyrrole)s, poly(thiophene)s, substituted poly(thiophene)s, poly(acetylene)s, poly(ethylene dioxythiophene)s, poly(ethylenedioxypyrrole)s, poly(p-phenylene vinylene)s, or the like, or combinations comprising at least one of the foregoing EAP's. Blends or copolymers or composites of the foregoing EAP's may also be used. Similarly blends or copolymers or composites of an EAP with an EAP precursor may also be used.

The active element used in the reconfigurable tool may also comprise a piezoelectric material. Also, in certain embodiments, the piezoelectric material may be configured for providing rapid reconfiguration. As used herein, the term “piezoelectric” is used to describe a material that mechanically deforms (changes shape) when a voltage potential is applied, or conversely, generates an electrical charge when mechanically deformed. Preferably, a piezoelectric material is disposed on strips of a flexible metal sheet. The strips can be unimorph or bimorph. Preferably, the strips are bimorph, because bimorphs generally exhibit more displacement than unimorphs.

In contrast to the unimorph piezoelectric device, a bimorph device includes an intermediate flexible metal foil sandwiched between two piezoelectric elements. Bimorphs exhibit more displacement than unimorphs because under the applied voltage one ceramic element will contract while the other expands. Bimorphs can exhibit strains up to about 20%, but similar to unimorphs, generally cannot sustain high loads relative to the overall dimensions of the unimorph structure.

Suitable piezoelectric materials include inorganic compounds, organic compounds, and metals. With regard to organic materials, all of the polymeric materials with non-centrosymmetric structure and large dipole moment group(s) on the main chain or on the side-chain, or on both chains within the molecules, can be used as candidates for the piezoelectric film. Examples of suitable polymers include, for example, but are not limited to, poly(sodium 4-styrenesulfonate) (“PSS”), poly S-119 (poly(vinylamine)backbone azo chromophore), and their derivatives; polyfluorocarbons, including polyvinylidene fluoride (“PVDF”), its co-polymer vinylidene fluoride (“VDF”), trifluoroethylene (TrFE), and their derivatives; polychlorocarbons, including poly(vinyl chloride) (“PVC”), polyvinylidene chloride (“PVC2”), and their derivatives; polyacrylonitriles (“PAN”), and their derivatives; polycarboxylic acids, including poly(methacrylic acid (“PMA”), and their derivatives; polyureas, and their derivatives; polyurethanes (“PUE”), and their derivatives; bio-polymer molecules such as poly-L-lactic acids and their derivatives, and membrane proteins, as well as phosphate bio-molecules; polyanilines and their derivatives, and all of the derivatives of tetramines; polyimides, including KAPTON® molecules and polyetherimide (“PEI”), and their derivatives; all of the membrane polymers; poly(N-vinyl pyrrolidone) (“PVP”) homopolymer, and its derivatives, and random PVP-co-vinyl acetate (“PVAc”) copolymers; and all of the aromatic polymers with dipole moment groups in the main-chain or side-chains, or in both the main-chain and the side-chains, and mixtures thereof.

Further, piezoelectric materials can include Pt, Pd, Ni, Ti, Cr, Fe, Ag, Au, Cu, and metal alloys and mixtures thereof. These piezoelectric materials can also include, for example, metal oxide such as SiO₂, Al₂0₃, ZrO₂, TiO₂, SrTiO₃, PbTiO₃, BaTiO₃, FeO₃, Fe₃O₄, ZnO, and mixtures thereof; and Group VIA and IIB compounds, such as CdSe, CdS, GaAs, AgCaSe 2, ZnSe, GaP, InP, ZnS, and mixtures thereof.

As noted above, the aforementioned active materials can be used in the active element of the reconfigurable tool. In one embodiment, the active element can be disposed as a coating (skin) on a core to form the reconfigurable tool. In another embodiment, the reconfigurable tool comprises a solid core that comprises an active element. The solid core may be coated with other materials that impart non-stick properties, or certain other design features to the molded part. In yet another embodiment, the active material can be temporarily pumped into a hollow housing such as a bladder either prior to, during or after the molding operation. The active material can be activated prior to, during and/or after the molding operation.

With reference now to the Figure, the reconfigurable tool 10 can be a mandrel that comprises a core 12 and an outer expandable skin 14. The outer expandable skin 14 can be a coating. The mandrel can be used in a molding operation. The outer expandable skin 14 is the active element and comprises a shape memory alloy. The core 12 can be solid or hollow and can be manufactured from a metal, a ceramic or a polymer that is in the form of bar stock, tubular stock, rail stock, or the like. During the molding operation (not shown), the outer expandable skin 12 is in an expanded configuration (first shape) during the preforming and molding operations, while it is in a contracted configuration (second shape) during the removal of the mandrel from the finished part.

In one embodiment, when the outer expandable skin 14 comprises a shape memory alloy, it is in its high temperature austenite state, when in the expanded configuration. The expanded configuration is therefore the memorized shape of the shape memory alloy that is used in the outer expandable skin 14. After the molding operation is completed, the temperature of the reconfigurable tool 10 is lowered so that the expandable skin 14 reverts to its lower temperature, lower modulus martensite state. In one embodiment, the temperature of the reconfigurable tool 10 can be lowered by cooling the molded component and the molding tools simultaneously under ambient conditions. In another embodiment, the reconfigurable tool 10 can be cooled separately from the molded component and other molding tools (i.e., the mold) by supplying a stream of cooling fluid (e.g., water, air, liquid nitrogen, or the like) directly to the reconfigurable tool 10. During the cooling of the mandrel, the core 10 can act as a bias spring to deform the outer expandable skin to its contracted configuration, which permits removal of the mandrel from the finished part.

In another embodiment, the contracted configuration (first shape) is the high temperature memorized state of the shape memory alloy in the outer expandable skin 14. The mandrel is therefore mechanically deformed to the expanded configuration (second shape) utilized for the molding operation, but once the molding operation is completed, the mandrel can be heated so as to return it to its memorized contracted configuration. It is then removed from the molded component.

As noted above, the use of a reconfigurable tool comprising a shape memory alloy permits the tool to have greater stiffness during the molding operation by maintaining the shape memory alloy in its austenitic state. This advantageously provides for molding parts that have tighter tolerances. Having the shape memory alloy transformed to its lower temperature, lower modulus, martensite state after the molding operation results in a softer mandrel that can be easily removed from the mold.

In one advantageous embodiment, a reconfigurable tool that comprises a shape memory alloy can attain its memorized shape only after molten resin is injected or poured into the mold or a heated sheet of thermoplastic material is inserted between mold and mandrel. This can be done in order to impart special features to the molded component. It can also be done to pressurize the thermoplastic sheet and or injected resinous material after it is placed/poured into the mold.

In another embodiment, the reconfigurable tool is a mandrel having as its active element a shape memory polymer. The mandrel is generally stiff (i.e., has a modulus of greater than or equal to about 10⁵ gigapascals (GPa)) during the -molding operation and is flexible (i.e., has a modulus of less than or equal to about 10⁵ gigapascals (GPa)) during the removal from the molded component after the molding operation is completed. The mandrel can be solid or hollow and can have a cross-sectional area that has any desired geometry. In one embodiment, the mandrel can have a non-uniform cross-sectional area and the cross-sectional area can encompass variations in geometry. For example, the mandrel can comprise a first section and a second section, wherein the first section is connected to the second cross-section and wherein the first cross-section is square in shape and has a cross-sectional area of 200 square centimeters, while the second cross-section is circular in shape and has a cross-sectional area of 100 square centimeters.

In one embodiment, a mandrel comprising the shape memory polymer will be stiff during the molding and cooling operation. After the molded component acquires a desired stiffness, the mandrel can be heated, thereby losing stiffness, which enables its easy removal from the molded component.

In another embodiment, the reconfigurable tool comprising an active material can be used as a replacement for a “bladder” during molding operations. As noted above, these reconfigurable tools can be advantageously used where an opening in a part that is to be molded is smaller in size than a cavity contained in the same part. In such an event, a reconfigurable tool in its contracted configuration can be introduced into the mold prior to the molding operation. The reconfigurable tool is then activated to its expanded state after the mold is closed to create the desired cavity. After the molding operation is completed, the reconfigurable tool is once again reduced to its contracted configuration and removed from the molded component. Using a reconfigurable tool in this manner permits the development of tight tolerances in molded components. It also permits better thickness control and surface finish in molded components than those molded using traditional bladders.

In another embodiment, metal strips comprising a shape memory alloy can be affixed to a traditional bladder prior to a molding operation. The use of such metal strips can facilitate the development of a desired shape when the bladder is heated. During a molding operation, the metal strips function by distorting the bladder to a desired shape when they are heated above their transition temperature. When the bladder is cooled, the stiffness of the metal strips is decreased. Those portions of the bladder that do not comprise a shape memory alloy are generally designed to function as a bias spring thereby returning the bladder to its original shape and in so doing deform the metal strips to their original shape as well.

In one embodiment, the reconfigurable tool can be made out of a SMP such that the memorized shape of the reconfigurable tool is the desired shape of the part that is to be molded. In this case the molding process starts with the reconfigurable tool in its desired shape and below the transition temperature of the SMP. The part is poured and molded. After the solidification of the part, the reconfigurable tool is then heated above the glass transition temperature (Tg) of the low temperature component of the SMP thereby dramatically increasing the flexibility of the reconfigurable tool and allowing it to be withdrawn from the molded component.

The increased flexibility of the reconfigurable tool upon heating above the glass transition temperature (Tg) of the low temperature component of the SMP, allows the tool to be advantageously designed and manufactured so that it can be used in a variety of configurations. For example, it can be withdrawn from hollow parts with irregularly shaped interior cavities and through openings substantially smaller in size than those of the cross sections of the cavities that they were used to create. It is desirable to maintain the reconfigurable tool at a temperature above the glass transition temperature (Tg) of the lower temperature component of the SMP after withdrawing from the molded component. This permits the reconfigurable tool to return to its original desired shape. Once in that shape it could be re-cooled for the next molding operation.

In another embodiment, related to the use of shape memory polymers, the hollow reconfigurable tool has a memorized first shape having at least one dimension that is smaller than the same dimension in a second shape. The second shape is that which is desired for the cavity of a series of molded components. To set the desired shape in the hollow reconfigurable tool for molding specific parts, the reconfigurable tool is inserted into a mold having this desired shape. The hollow reconfigurable tool is then heated above the glass transition temperature of its lower temperature segment, this dramatically dropping its modulus, and then it is inflated to its desired second shape. The reconfigurable tool in its second shape is referred to as the new reconfigurable tool. The inflation may be accomplished with a fluid such as air, water, nitrogen, steam, or the like. After inflation, the reconfigurable tool is cooled thereby increasing its elastic modulus and acquiring rigidity in the desired second shape. The reconfigurable tool is then used in a second mold to create a number of molded components having identical geometrical features. After the molding operation is completed, the active element of the reconfigurable tool can be reactivated to return the tool to its first shape.

In another embodiment, involving the use of an electrorheological fluid or magnetorheological fluid, a hollow reconfigurable tool made from a flexible material may be inserted in the mold prior to pouring the molten polymeric resin, metal or ceramic into the mold. Examples of such hollow reconfigurable tools are hollow mandrels or bladders. Either prior to or during the pouring, a magnetorheological or electrorheological fluid is pumped or poured into the hollow reconfigurable tool. Air bubbles and air pockets are removed from the tool. An appropriate electrical and/or magnetic field may be applied to the reconfigurable tool either prior to, during, or immediately after the pouring of the melt has occurred. The application of the electrical and/or magnetic field to the reconfigurable tool allows it to solidify and to support the melt surrounding it. Following the removal of the electrical and/or the magnetic field, the magnetorheological and/or the electrorheological fluid reduces in viscosity and is removed from the reconfigurable tool. The hollow reconfigurable tool may then be removed.

In another embodiment, EAP's, piezoceramics and magnetorheological elastomers can be used in the reconfigurable tools. The EAP's, piezoceramics and magnetorheological elastomers can all be activated by the application of electric or magnetic fields. All three can exhibit reversible measurable changes in geometry and/or dimensions in response to the application of the appropriate stimulus. These changes in geometry and/or dimensions can be used in a similar fashion-to that described above for shape memory alloys as the enabling elements of reversible reconfigurable tools.

In one embodiment, an elastomeric mold for manufacturing articles may contain an active material. After pouring the melt into the mold, the active material can be activated by using external stimulus to impart certain special effects such as indentations, or the like, to the article. The external stimulus may promote a change in orientation of the active materials contained in the elastomeric mold to impart the special effects.

While the disclosure has been described with reference to an exemplary embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

1. A reconfigurable tool for use in a mold comprising:
an active element that comprises an active material, wherein the active element upon activation is operative to permit insertion or removal of the reconfigurable tool from an opening in the mold or a molded part.

2. The reconfigurable tool of claim 1, wherein the active material is a shape memory alloy, an electroactive polymer, a piezoelectric, a piezoceramic, a ferromagnetic shape memory alloy, a shape memory polymer, a magnetostrictive material, an electrorheological fluid, a magnetorheological fluid, a magnetorheological elastomer or a combination comprising at least one of the foregoing active materials and wherein the activation of the active material is promoted by electricity, magnetism, thermal energy, radiation, chemical energy, or a combination comprising at least one of the foregoing stimuli.

3. The reconfigurable tool of claim 1, comprising a mold, a mandrel, a bladder, a die or mold insert, or a combination comprising at least one of the foregoing.

4. The reconfigurable tool of claim 1, wherein the active element is a coating disposed on a core.

5. The reconfigurable tool of claim 4, wherein the core is solid, and wherein the core comprises bar stock, rail stock, or a combination thereof.

6. The reconfigurable tool of claim 4, wherein the core is hollow, and wherein the core comprises tube stock.

7. The reconfigurable tool of claim 1, wherein the active element is disposed in a flexible housing.

8. The reconfigurable tool of claim 7, wherein the flexible housing comprises a thermoplastic polymeric resin, a thermosetting polymeric resin or a combination thereof.

9. The reconfigurable tool of claim 1, wherein the activation facilitates a change from a first shape to a second shape, a change in at least one dimension, or a change from a first elastic modulus to a second elastic modulus.

10. The reconfigurable tool of claim 9, wherein the first elastic modulus is greater than the second elastic modulus.

11. The reconfigurable tool of claim 9, wherein the second elastic modulus is greater than the first elastic modulus.

12. A method for using a reconfigurable tool during a molding operation comprising:
pouring a molten polymeric resin, metal, ceramic, or a combination comprising a molten polymeric resin, metal or ceramic into a mold that comprises a reconfigurable tool, wherein the reconfigurable tool comprises an active element that is activated upon the application of an external stimulus; and
activating the active element.

13. The method of claim 12, wherein activating the active element is used to impart desired features to the molded component.

14. The method of claim 12, wherein the activating the active element is used to facilitate removal of the reconfigurable tool from the mold.

15. The method of claim 12, wherein the active material is a shape memory alloy, an electroactive polymer, a piezoelectric, a piezoceramic, a ferromagnetic shape memory alloy, a shape memory polymer, a magnetostrictive material, an electrorheological fluid, a magnetorheological fluid, a magnetorheological elastomer or a combination comprising at least one of the foregoing active materials and wherein the activation of the active material is promoted by electricity, magnetism, thermal energy, radiation, chemical energy, or a combination comprising at least one of the foregoing external stimuli.

16. The method of claim 12, wherein the activating of the active element takes place either prior to, during or after the pouring of the molten polymeric resin, metal, ceramic, or a combination comprising the molten polymeric resin, metal or ceramic into the mold.

17. The method of claim 12, wherein the activating promotes a change in stiffness, a change in shape and/or a change in dimensions of the reconfigurable tool.

18. The method of claim 12, wherein the activating increasing the stiffness of the tool.

19. The method of claim 12, further comprising deactivating the reconfigurable tool.

20. The method of claim 19, further comprising removing the reconfigurable tool from a molded part.

21. The method of claim 19, wherein deactivating reduces the stiffness of the reconfigurable tool.

22. A method comprising:
inserting a hollow reconfigurable tool comprising an active element and having a first shape and/or a first set of dimensions into a first mold;
activating the active element;
inflating the reconfigurable tool;
deactivating the active element to lock in a second shape and/or a second set of dimensions in the reconfigurable tool to form a new reconfigurable tool;
depressurizing the new reconfigurable tool; and
removing the new reconfigurable tool from the first mold.

23. The method of claim 22; further comprising using the new reconfigurable tool in a second mold to mold an object of a desired shape.

24. The method of claim 22, further comprising activating the active element to return the new reconfigurable tool to a first shape and/or a first set of dimensions.
